(19) United States
(12) Patent Application Publication
(10) Pub. No.: US 2025/0225583 A1
(43) Pub. Date: Jul. 10, 2025

(54) TimeCurrency Protocol _A Global Infrastructure for Time-Based Wealth, Banking, and Economic Equity

(71) Applicant: FURONG BEI, SAN GABRIEL, CA (US)

(72) Inventor: FURONG BEI, SAN GABRIEL, CA (US)

(21) Appl. No.: 19/091,590

(22) Filed: Mar. 26, 2025

(51) Int. Cl. G06Q 40/04; G06Q 10/1091

(52) U.S. Cl. CPC G06Q 40/04; G06Q 10/1091; G06Q 2220/00

(57) ABSTRACT

The TimeCurrency Protocol provides a decentralized system to convert human-verified time into tradable TimeTokens. These tokens serve as a universal unit of economic value, stored within smart-contract-driven TimeBanks and governed by a distributed TimeLedger system. The protocol enables users to accumulate, exchange, save, or inherit time-based assets. Through TimeGates, these TimeTokens can be exchanged for fiat, goods, or services. The invention introduces UBTI (Universal Basic Time Income), Time Vaults for savings, and TimeDAO governance for collective decision-making. This innovation supports financial inclusion, bridges traditional and decentralized finance, and redefines the foundation of wealth through time.

### TECHNICAL FIELD

The invention relates to decentralized digital financial infrastructure. Specifically, it concerns a protocol for transforming verified human time into tradable digital economic units (“TimeTokens”), establishing a universal TimeBank System, and managing a time-based wealth ledger to support financial equity among 8 billion global citizens.

### BACKGROUND

Modern monetary systems undervalue non-monetized human effort such as caregiving, community service, and learning. Billions lack access to traditional banking. Time—the one resource everyone equally possesses—remains unmonetized, unbanked, and unrecognized.

TimeCurrency Protocol introduces a breakthrough: formalizing and digitizing human time as a unit of verified, stored, exchanged, and inherited economic value.

### SUMMARY OF THE INVENTION

This invention provides:
A protocol that converts verified labor hours into blockchain-tracked TimeTokens;
A distributed TimeBanking system allowing individuals to save, loan, and spend time-based value;
A global ledger to authenticate, transfer, and allocate TimeTokens across borders, industries, and applications.

The invention connects personal contribution to usable value, allowing direct participation in economic systems through time rather than capital.

### TECHNICAL DETAILS

1. TimeToken Generator: Validated time input (via app, device, institution) creates cryptographic TimeTokens.
2. TimeBank Modules: Each person, family, city, and nation hosts a smart contract-based wallet tracking TimeCredits.
3. TimeLedger System: A decentralized, permissioned ledger stores time transactions with metadata (e.g., skill type, service type, location).
4. TimeGate Exchange Layer: Enables conversion between TimeTokens, fiat currencies, or goods (e.g., water, food, education).
5. TimeVaults: Long-term saving smart contracts for individuals or communities.
6. UBTI Engine: Annual Universal Basic Time Income distributed algorithmically to verified users.
7. TimeDAO Governance: Voting and proposals weighted by validated TimeCredit history.
8. SDG Compliance Layer: Reports time impact against UN Sustainable Development Goals (1, 5, 8, 10, 17).
9. API Integration Layer: Enables third parties (apps, governments, NGOs) to embed TimeCurrency modules.

### Advantages

Enables banking for the unbanked;
Creates economic value from non-capital labor;
Strengthens intergenerational equity via inheritable Time Vaults;
Empowers local economies with decentralized savings;
Bridges traditional and Web3 finance using universally accessible input: time.

### APPLICATIONS

Public services (elder care, education, health);
Local government resource allocation;
Refugee & disaster resilience credits;
Remote worker compensation systems;
Microloan & micro-insurance collateralization;
Smart subsidies for family caregivers;
Alternative GDP and economic productivity tracking.

1. A protocol-based system that converts human-verified labor time into tradable digital tokens (TimeTokens), secured and tracked on a blockchain ledger.

2. A decentralized TimeBanking structure comprising personal, institutional, and national smart contract-driven TimeCredit wallets that store, lend, and inherit TimeTokens.

3. A TimeLedger governance mechanism for validating, synchronizing, and overseeing global time-based transactions, inclusive of metadata and dynamic valuation modules.

4. The system of claim 1, wherein TimeTokens are redeemable for essential goods and services including but not limited to food, water, housing, education, and healthcare.

5. The system of claim 2, wherein TimeBanks support multi-tiered time storage options, including personal, family, city, and nation-level vaults.

6. The system of claim 1, wherein TimeGates enable real-time exchange between TimeTokens and fiat currencies, crypto-assets, or physical commodities.

7. The system of claim 1, wherein UBTI (Universal Basic Time Income) is algorithmically distributed to verified users on a periodic basis.

8. The system of claim 3, wherein TimeLedger integrates smart contract-based validation of time contributions using device input or institutional certification.

9. The system of claim 1, further comprising an API framework to allow third-party services and applications to interface with the protocol.

10. The system of claim 2, wherein TimeCredit reputation scores are calculated based on contribution quality, consistency, and social impact.

11. The system of claim 3, wherein a TimeDAO governs protocol upgrades, allocation policies, and dispute resolution.

12. The system of claim 2, wherein TimeTokens can be inherited by family members through programmable smart contracts.

13. The system of claim 1, wherein all transactions are stored on a transparent, tamper-proof blockchain ledger.

14. The system of claim 3, wherein time valuations adjust dynamically based on scarcity, geography, or skill demand.

15. The system of claim 1, wherein TimeTokens can be used as collateral for microloans or digital asset staking.

16. The system of claim 2, wherein TimeBanks can serve as alternative credit institutions in underbanked regions.

17. The system of claim 3, wherein transaction metadata is linked to SDG compliance indicators.

18. The system of claim 1, wherein Time Vaults function as long-term savings mechanisms, accruing value and compounding via social participation.

19. The system of claim 2, wherein each user possesses a digital TimeID to unify accounts and record contributions across platforms.

20. The system of claim 3, wherein the TimeLedger integrates with national accounting systems for GDP alternatives and fiscal policy modeling.
